(19) United States
(12) Patent Application Publication
(10) Pub. No.: US 2012/0273403 A1
(43) Pub. Date: Nov. 1, 2012

(54) RECLAIMER SYSTEM

(76) Inventors: Thomas E. Daniels, Lexington, KY (US); Jeremy N. Fuhr, Lexington, KY (US)

(21) Appl. No.: 13/094,294

(22) Filed: Apr. 26, 2011

(51) Int. Cl. E21B 21/01; B01D 35/02; B65G 19/00

(52) U.S. Cl. 210/170.01; 198/728

(57) ABSTRACT

A reclaimer system for removing solid material from a fluid-filled pit. The reclaimer system comprises a screen, a pump, and a conveyor. The screen is positioned within the pit such that the pit is divided into a first portion and a second portion. The screen includes a plurality of openings. The pump is positioned in the first portion of the pit and includes at least one intake port in fluid communication with the first portion of the pit. The conveyor is positioned in the second portion of the pit adjacent the screen. The conveyor includes a frame, a belt, a plurality of flight members mounted on the belt, and a conveyor deck. The flight members are mounted on the belt and move the solid material along the conveyor deck, carrying the solid material out of the pit.

### BACKGROUND

The invention relates to the field of mining conveyors and, in particular, a conveyor system for removing solid material from a sump pit.

Conventional mining operations typically result in formation of slurry waste in sump pits. A pump is often used to transport the waste deposits to another location. Because solid materials may mix with the waste deposits, a screen is provided around the pump to prevent the intake of any unwanted solid materials. However, solid material accumulates around the screen, which restricts the flow of waste into the pump

### SUMMARY OF THE INVENTION

In one embodiment, the invention provides a reclaimer system for use with a fluid filled pit containing solid material. The reclaimer system includes a screen having a first side and an opposing second side, a pump, and a conveyor. The screen is positioned within the pit such that the pit is divided into a first portion on the first side of the screen and a second portion on the second side of the screen. The screen includes a plurality of openings, and each of the openings has an opening height and an opening width. Each of the openings is sized to prevent material larger than the opening height or the opening width from moving from the second portion of the pit to the first portion of the pit. The pump is positioned in the first portion of the pit and includes an intake port in communication with the pit. The conveyor is positioned at least partially in the second portion of the pit and proximate to the second side of the screen. The conveyer includes a first run and a second run, with the first run being located at least partially within the pit and including a discharge that is located outside of the pit. Material in the second portion of the pit is carried by the conveyor out of the pit.

In another embodiment the invention provides a conveyor including a frame having a base, a continuous belt, a plurality of flight members, and a deck. The continuous belt includes a travel direction and defines a first run and a second run. The plurality of flight members are coupled to the continuous belt and separated by a flight spacing distance. The flight spacing distance is parallel to the travel direction. The deck is located along a length of the first run and below the flight members. Each flight member includes a first side facing the deck.

Another embodiment of the invention provides a method for removing material from a fluid filled pit containing solid material, with the pit having a first portion and a second portion. The method includes pumping fluid material in the first portion of the pit through an intake port in communication with the first portion of the pit; screening a fluid-filled pit such that the pit is divided into the first portion on a first side of a screen and the second portion on a second side of the screen, wherein the screen includes a plurality of openings, each of the openings having an opening height and an opening width and being sized to prevent material having a dimension larger than the opening height or the opening width from moving from the second portion of the pit to the first portion of the pit; collecting solid material in the second portion of the pit on at least one conveyor deck positioned proximate to the second side of the screen; carrying the solid material along a first run of a conveyor; and discharging the solid material in a location outside of the pit.

Other aspects of the invention will become apparent by consideration of the detailed description and accompanying drawings.

### BRIEF DESCRIPTION OF THE DRAWINGS

FIG. 1 is a perspective view of a reclaimer system.

FIG. 2 is a plan view of the reclaimer system of FIG. 1.

FIG. 3 is a front view of the reclaimer system of FIG. 1.

FIG. 4 is an enlarged view of a portion of the reclaimer system of FIG. 3.

FIG. 5 is a section view of the reclaimer system taken along line 5-5 shown in FIG. 3.

FIG. 6 is an enlarged view of the reclaimer system shown in FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

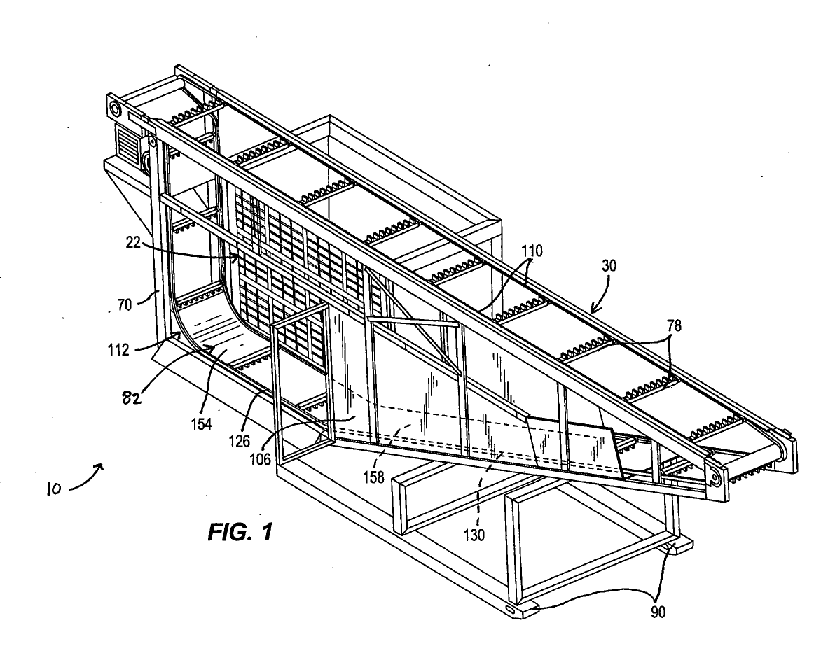

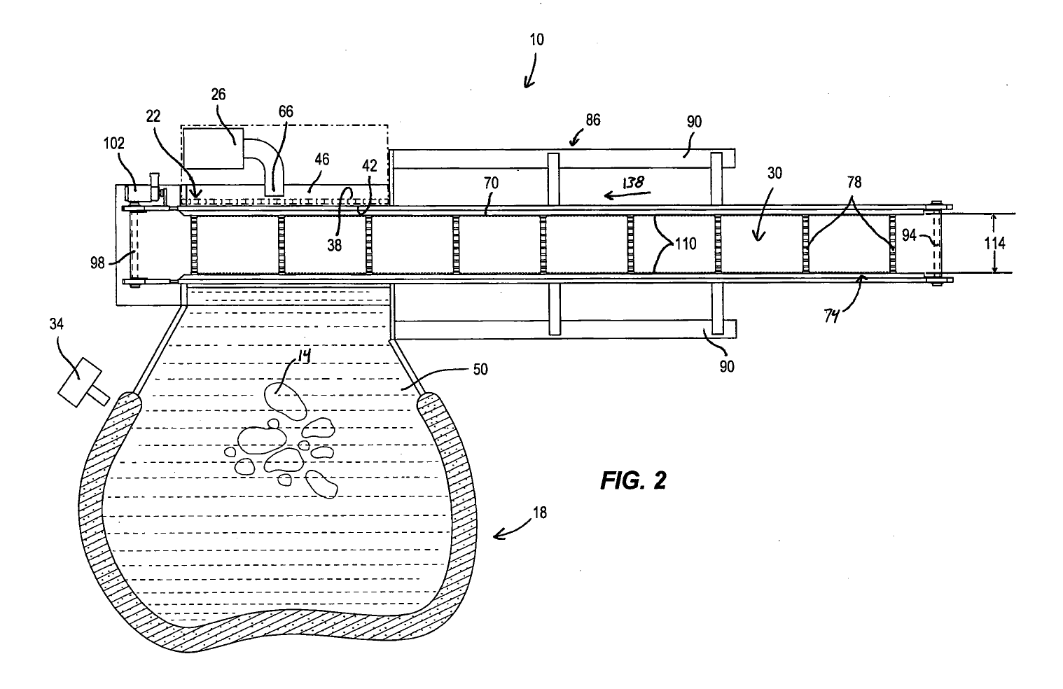

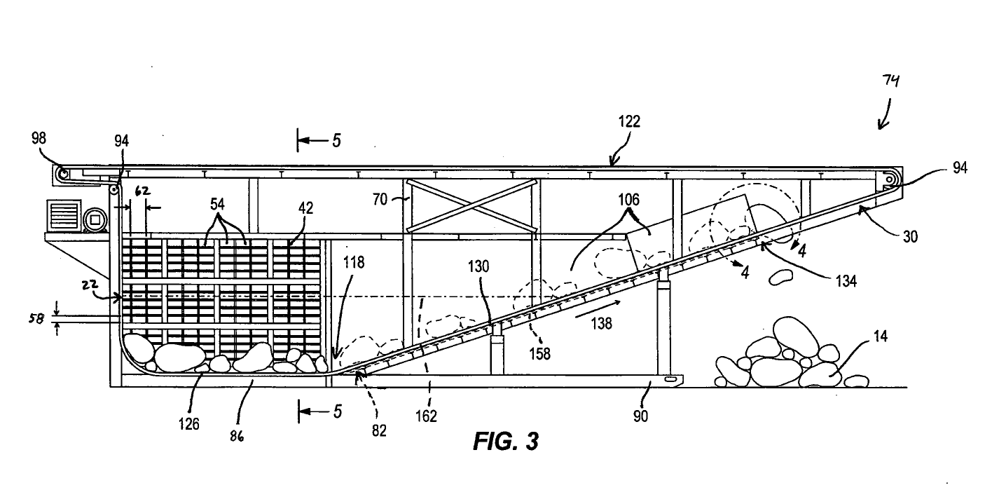

FIG. 1 illustrates a reclaimer system 10 according to one embodiment of the invention. The reclaimer system 10 removes solid material 14 from a fluid-filled pit 18 (FIG. 2). Referring to FIG. 2, the reclaimer system 10 includes a grill or screen 22, a pump 26, a conveyor 30, and a water cannon 34. The screen 22 has a first side 38 and an opposing second side 42, and is positioned within the pit 18 such that the pit 18 is divided into a first portion 46 on the first side 38 of the screen 22 and a second portion 50 on the second side 42 of the screen 22. As shown in FIGS. 2 and 3, the screen 22 includes a plurality of openings 54 (FIG. 3), and each of the openings 54 has an opening height 58 and an opening width 62 such that material having a dimension greater than the opening height 58 and the opening width 62 cannot pass through the screen 22 from the second portion 50 of the pit 18 to the first portion 46 of the pit 18. The screen 22 permits fluid in the second portion 50 to pass to the first portion 46. The pump 26 is positioned in the first portion 46 of the pit 18 and includes at least one intake port 66 (FIG. 2) in fluid communication with the first portion 46 of the pit 18.

As shown in FIGS. 2 and 3, the conveyor 30 is positioned at least partially in the second portion 50 of the pit 18 and proximate to the second side 42 of the screen 22. The conveyor 30 includes a frame 70, a continuous belt 74, a plurality of flight members 78 mounted on the belt 74, and a conveyor deck 82 (FIG. 1). The frame 70 includes a base member 86 that supports the conveyor 30. The base member 86 includes a pair of skid members 90 coupled to the base member 86 to facilitate transportation of the conveyor 30. At least a portion of the base member 86 is positioned within the pit 18. The frame 70 includes idler shafts 94 and a drive shaft 98 powered by a motor 102 (FIG. 2). The frame 70 also includes side walls 106 (also shown in FIG. 1).

As shown in FIG. 2, the belt 74 is passed around the drive shaft 98 and the idler shafts 94. In the illustrated embodiment, the belt 74 is formed by a pair of parallel chains 110. The parallel chains 110 are spaced apart by a belt width 114.

As shown in FIG. 3, the belt 74 includes a first run 118 and a second run 122. The first run 118 includes a first segment 126 and a second segment 130. The first segment 126 is substantially horizontal and is located in the second portion 50 of the pit 18 adjacent the bottom of the second side 42 of the screen 22. The second segment 130 is inclined, extending at an upward angle away from the first segment 126 and out of the pit 18. A portion of the second segment 130 extends between the side walls 106. In one embodiment, the second segment 130 is inclined at an angle no greater than 18° above horizontal, that is, 18° relative to a plane defined by the first segment 126 of the conveyor 30. The first run 118 includes a discharge 134 located outside of the pit 18.

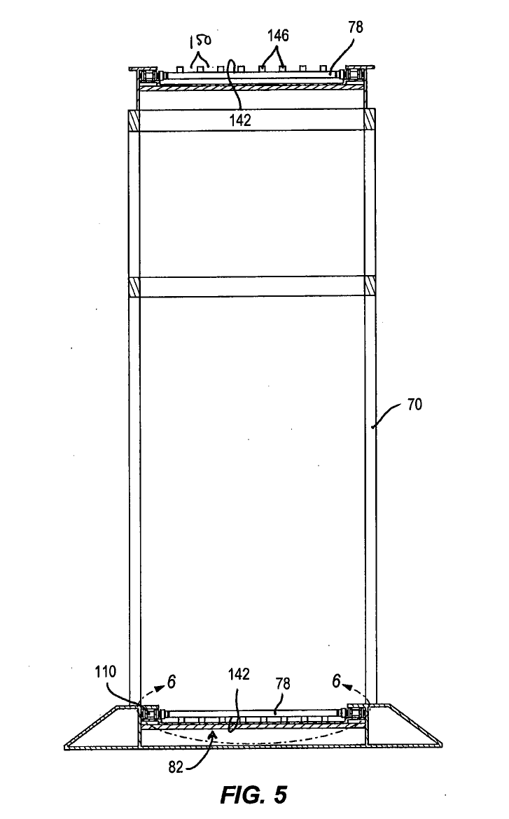

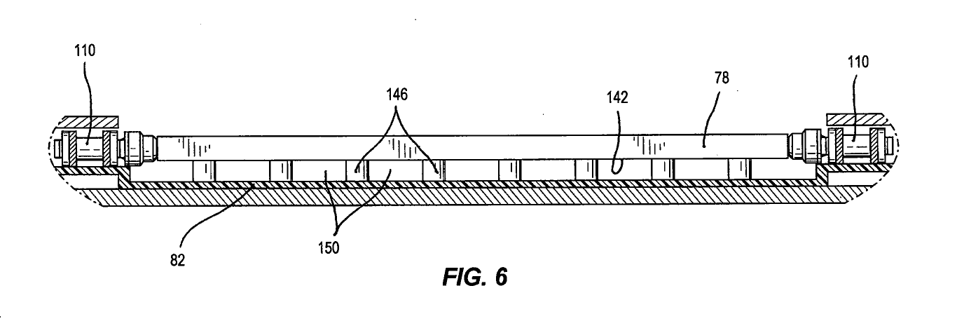

Referring again to FIGS. 2 and 3, the flight members 78 are spaced at regular intervals along the belt 74 and positioned substantially transverse to a direction of travel 138 of the belt 74. In the illustrated embodiment, each flight member 78 extends between the chains 110. As shown in FIGS. 5 and 6, each flight member 78 includes a first side 142 such that the first side 142 is adjacent the conveyor deck 82 when the flight member 78 travels through the first run 118. Each flight member 78 further includes a plurality of protrusions, or grousers 146, extending from the first side 142 along the length of the flight member 78. Each grouser 146 is separated from a neighboring grouser 146 by a space 150. The flight members 78 may be formed from any suitable material, including steel, and may have any suitable shape, including a tube having a circular cross-section or a rectangular cross-section.

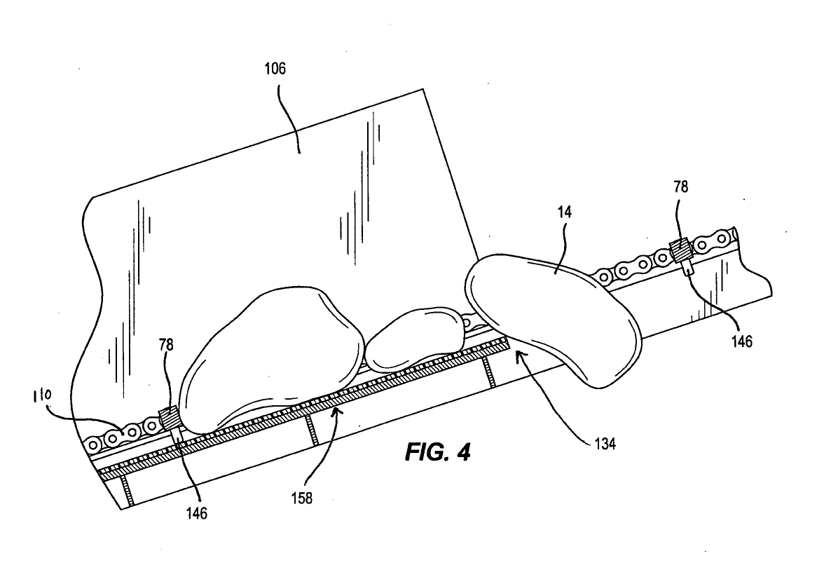

As shown in FIGS. 1 and 3 the conveyor deck 82 is coupled to the frame 70 and comprises a first portion 154 and a second portion 158. The first portion 154 is substantially horizontal and is located parallel to the first segment 126 of the first run 118 and immediately below the flight members 78. The second portion 158 is inclined at an angle equal to the angle of the second segment 130 of the first run 118 and extends above a water line 162 and out of the pit 18. A portion of the second portion 158 is located between the side walls 106. The second portion 158 is parallel to the second segment 130 of the first run 118 and immediately below the flight members 78. As shown in FIGS. 3 and 4, the discharge 134 is defined by the end of the second portion 158. In the illustrated embodiment, the conveyor deck 82 is formed from a flat sheet of corrosion-resistant material.

The water cannon 34 is positioned outside of the pit 18 and positioned on one side of the pit 18. The water cannon 34 sprays water at high pressure, which assists in breaking down the solid material 14, or urging the solid material 14 toward the conveyor deck 82 so that the solid material 14 can be transported out of the pit 18.

During normal operation, the pump 26 operates to remove the fluid from the pit 18. Solid material 14 is collected on the first portion 154 of the conveyor deck 82 in the second portion 50 of the pit 18 adjacent the second side 42 of the screen 22, which inhibits fluid from passing through the screen 22 and into the intake port 66 of the pump 26. The conveyor 30 is turned on by activating the motor 102 to rotate the drive shaft 98. The conveyor 30 may operate continuously, or the conveyor 30 may be operated when the volume of solid material 14 collected on the first portion 154 reaches a predetermined level. As the drive shaft 98 rotates, the belt 74 cycles through the first run 118 and then through the second run 122. The belt 74 passes over the idler shafts 94, which maintain tension in the belt 74. The flight members 78 in the first run 118 travel parallel to the conveyor deck 82, urging the solid material 14 in the direction of travel 138 of the belt 74. The grousers 146 contact the second portion 158 of the conveyor deck 82, catching the solid material 14 and preventing the solid material 14 from passing between the first side 142 of the flight members 78 and the second portion 158. Fluid may pass between the first side 142 and the second portion 158 via the space 150 between each grouser 146 (FIG. 6).

The flight members 78 carry the solid material 14 through the first run 118 and along the second portion 158 of the conveyor deck 82. As the solid material 14 moves along the second portion 158 of the deck 82, the solid material 14 is carried above the waterline 162 and out of the pit 18. The side walls 106 prevent the solid material 14 from falling over the sides of the belt 74 before reaching the discharge 134. As shown in FIG. 4, as the solid material 14 approaches the end of the first run 118, the solid material 14 enters the discharge 134 (i.e., where the deck 82 ends). The solid material 14 falls away from the belt 74 and is deposited in an area below the belt 74 and out of the pit 18. The flight members 78 travel through the second run 122 before cycling back to the first run 118.

In another embodiment, the conveyor 30 may be configured such that the solid material 14 passing through the discharge 134 is deposited on a second conveyor that carries the solid material 14 away to another site for further processing.

Thus, the invention provides, among other things, a reclaimer system for removing solid material from a fluid-filled pit. Various features and advantages of the invention are set forth in the following claims.

What is claimed is:

1. A reclaimer system for use with a fluid filled pit containing solid material, the reclaimer system comprising:
a screen including a first side and an opposing second side, the screen positioned within the pit such that the pit is divided into a first portion on the first side of the screen and a second portion on the second side of the screen, and the screen including a plurality of openings, each of the openings having an opening height and an opening width and being sized to prevent material larger than the opening height or the opening width from moving from the second portion of the pit to the first portion of the pit;
a pump positioned in the first portion of the pit and including an intake port in communication with the pit; and
a conveyor positioned at least partially in the second portion of the pit and proximate to the second side of the screen, the conveyer including a first run and a second run, the first run being located at least partially within the pit and including a discharge located outside of the pit,
wherein material in the second portion of the pit is carried by the conveyor out of the pit.

2. The reclaimer system of claim 1, wherein the material in the second portion of the pit carried by the conveyor out of the pit has a dimension larger than the opening height or the opening width.

3. The reclaimer system of claim 1, wherein the conveyor is a chain conveyor comprising a pair of parallel chains spaced apart by a belt width.

4. The reclaimer system of claim 1, wherein the first run extends in a direction parallel to the screen.

5. The reclaimer system of claim 1, wherein the conveyor further comprises a plurality of flight members spaced at regular intervals along the conveyor and the flight members carry the material along the conveyor.

6. The reclaimer system of claim 5, wherein the conveyor further comprises a conveyor deck located along a length of the first run of the conveyor and below the flight members.

7. The reclaimer system of claim 6, wherein the conveyor deck terminates prior to the second run of the conveyor and the material falls through the discharge upon moving beyond the conveyor deck.

8. The reclaimer system of claim 7, wherein the discharge of the conveyor is defined by a lack of conveyor deck below the flight members along the first run.

9. The reclaimer system of claim 5, wherein each of the flight members has a first side located proximate to the conveyor deck and a plurality of grousers extending from the first side, the grousers being adapted to catch solid material and prevent the solid material from passing between the first side of the flight members and the conveyor deck.

10. The reclaimer system of claim 1, wherein the conveyor is driven by a motor having a power source.

11. The reclaimer system of claim 1, wherein the first run includes a first segment and a second segment.

12. The reclaimer system of claim 11, wherein the second segment is inclined at an angle no greater than 18 degrees relative to the first segment.

13. The reclaimer system of claim 1, further including a high-pressure water hose positioned outside the pit and adjacent to the screen.

14. A conveyor comprising:
a frame including a base;
a continuous belt including a travel direction and defining a first run and a second run;
a plurality of flight members coupled to the continuous belt and separated by a flight spacing distance, the flight spacing distance being parallel to the travel direction;
a deck located along a length of the first run and below the flight members,
wherein each flight member includes a first side facing the deck.

15. The conveyor of claim 14, wherein the base includes at least one skid member.

16. The conveyor of claim 14, wherein the continuous belt includes a pair of parallel chains spaced apart by a belt width.

17. The conveyor of claim 14, wherein the flight members have a tubular shape.

18. The conveyor of claim 14, wherein the flight members are oriented substantially transverse to the direction of the first run.

19. The conveyor of claim 14, wherein the first run includes a discharge defined by a lack of conveyor deck below the flight members and along a portion of the first run of the conveyor.

20. The conveyor of claim 14, wherein each of the flight members includes a plurality of grousers positioned on the first side of the flight member.

21. The conveyor of claim 14, wherein the conveyor is powered by a motor, causing the continuous belt to move in the travel direction.

22. The conveyor of claim 14, wherein the first run includes a first segment and a second segment.

23. The conveyor of claim 22, wherein the second segment is inclined at an angle no greater than 18 degrees relative to the first segment.

24. A method for removing material from a fluid filled pit containing solid material, the pit having a first portion and a second portion, the method comprising:
pumping fluid material in the first portion of the pit through an intake port in communication with the first portion of the pit;
screening a fluid-filled pit such that the pit is divided into the first portion on a first side of a screen and the second portion on a second side of the screen, wherein the screen includes a plurality of openings, each of the openings having an opening height and an opening width and being sized to prevent material having a dimension larger than the opening height or the opening width from moving from the second portion of the pit to the first portion of the pit;
collecting solid material in the second portion of the pit on at least one conveyor deck positioned proximate to the second side of the screen;
carrying the solid material along a first run of a conveyor; and
discharging the solid material in a location outside of the pit.

25. The method for removing material of claim 24, wherein collecting the solid material further comprises spraying the solid material with a high-pressure water cannon to urge the solid material toward the conveyor deck.

26. The method for removing material of claim 24, wherein carrying the solid material further comprises urging the solid material along the conveyor deck with a plurality of flight members spaced at regular intervals along the conveyor.

27. The method for removing material of claim 24, wherein discharging the solid material comprises passing the solid material to the area below the conveyor once the solid material is carried beyond the conveyor deck.
